(19) United States
(12) Patent Application Publication
(10) Pub. No.: US 2014/0378609 A1
(43) Pub. Date: Dec. 25, 2014

(54) INK, INK CARTRIDGE, AND INK JET RECORDING METHOD

(71) Applicant: Canon Kabushiki Kaisha, Tokyo (JP)

(72) Inventors: Kousuke Yamasaki, Kawasaki-shi (JP); Daiji Okamura, Tokyo (JP)

(21) Appl. No.: 14/308,438

(22) Filed: Jun. 18, 2014

(30) Foreign Application Priority Data
Jun. 20, 2013 (JP) 2013-130038

(51) Int. Cl. C09D 11/324; C09D 11/102; C09D 175/08

(52) U.S. Cl. CPC C09D 11/324; C09D 175/08; C09D 11/102
USPC 524/590; 347/86; 347/20

(57) ABSTRACT

An ink for ink jet contains a pigment and a urethane resin. The pigment is at least one of a pigment the particles of which have an anionic group bonded to their surface directly or via another atomic group and a pigment dispersed by a resin having an anionic unit and different from the urethane resin. The urethane resin has a unit derived from a polyfunctional polyisocyanate, and this unit has at least one structure selected from the group consisting of an allophanate structure that has added a monohydric alcohol containing 1 to 5 carbon atoms, a uretdione structure, an isocyanurate structure, and a biuret structure. The acid value of the urethane resin is less than 10 mg KOH/g.

### BACKGROUND OF THE INVENTION

1. Field of the Invention

The present invention relates to an ink, an ink cartridge, and an ink jet recording method.

2. Description of the Related Art

Ink jet recording with the use of plain paper as a record medium has also been utilized in printing of business text and other documents that include characters, tables, and figures, at a rapidly increasing frequency in such applications. In such applications an ink in which pigment is used as a coloring material (pigment ink) is often used because high levels of color development and fastness of images (resistance to light, ozone gas, water, etc.) are required.

A factor in the superior color development of images recorded with pigment ink compared to that with an ink in which dye is used as a coloring material (dye ink) is a large amount of coloring material on the surface of the record medium. This is because dye permeates deep into a record medium, whereas pigment quickly aggregates because of the evaporation of liquid components during or after the application of the ink to a record medium. Pigment ink, however, causes a low scratch resistance of images because the pigment as a coloring material often remains on the surface of a record medium. It has been attempted to add urethane resin to ink to improve the characteristics, for example, of images recorded with pigment ink (refer to Japanese Patent Laid-Open No. 2006-022132, Japanese Patent Laid-Open No. 2012-140602, and Japanese Patent Laid-Open No. 2013-035897).

The inventors studied the disclosed pigment inks afresh. The ink described in Japanese Patent Laid-Open No. 2006-022132 contains, as a dispersant for pigment, a urethane resin modified with a polyethylene glycol monomethyl ether-added allophanate. The ink described in Japanese Patent Laid-Open No. 2012-140602 is a pigment ink that contains a urethane resin modified with a polyethylene glycol monomethyl ether-added allophanate. These inks were found to be of low intermittent ejection stability, and images recorded with these inks also lacked sufficient scratch resistance. The ink described in Japanese Patent Laid-Open No. 2013-035897 contains a urethane resin modified with an isocyanurate. This ink was found to be of insufficient scratch resistance of images recorded therewith.

Intermittent ejection stability can be described as follows. Recording an image by ink jet recording with no ink being ejected from a certain nozzle of a recording head leads to water in the ink evaporating out of the nozzle. Trying to eject the next drop of ink from this nozzle causes unwanted situations such as instable ejection of the ink and failed ejection. An ink that causes such a situation is of low intermittent ejection stability, and no ink has been found with which images can be recorded with excellent scratch resistance and satisfactory intermittent ejection stability.

### SUMMARY OF THE INVENTION

According to aspects of the invention, an ink may be provided with which an image can be recorded with excellent scratch resistance and satisfactory intermittent ejection stability, and an ink cartridge and an ink jet recording method in which this ink is used may also be provided.

An ink according to an aspect of the invention is an ink for ink jet that contains a pigment and a urethane resin. The pigment contains at least one of a pigment the particles of which have an anionic group bonded to their surface directly or via another atomic group and a pigment dispersed by a resin having an anionic unit and different from the urethane resin. The urethane resin contains a unit derived from a polyfunctional polyisocyanate, and this unit has at least one structure selected from the group consisting of an allophanate structure that has added a monohydric alcohol containing 1 to 5 carbon atoms, a uretdione structure, an isocyanurate structure, and a biuret structure. The acid value of the urethane resin is less than 10 mg KOH/g.

Certain aspects of the invention may provide an ink with which an image can be recorded with excellent scratch resistance and satisfactory intermittent ejection stability and an ink cartridge and an ink jet recording method in which this ink is used.

### DESCRIPTION OF THE EMBODIMENTS

The following describes some aspects of the invention in detail by referring to preferred embodiments. An ink for ink jet may be simply referred to as “ink.” An anionic group as a component of a salt may be in the form of ion in ink as a result of dissociation but is described as “an anionic group” for the sake of convenience. The values of the characteristics mentioned herein are values at normal temperature (25° C.) unless otherwise specified.

Urethane resin is, in a broad sense, a resin synthesized with the use of a (poly)isocyanate. A urethane resin commonly used in inks for ink jet is synthesized with the use of at least polyisocyanate and a polyol or a polyamine, optionally with a polyol or a polyamine as a cross-linking agent or a chain extender. A urethane resin synthesized with the use of such components has two major segments, a hard segment and a soft segment. The hard segment is made up of units derived from components such as polyisocyanate, a short-chain polyol (e.g., an acid-group-containing diol) or a polyamine, and a cross-linking agent or a chain extender, mainly contributing to the strength of the urethane resin. The soft segment is made up of units derived from components such as a long-chain polyol, mainly contributing to the flexibility of the resin. Film made from urethane resin (hereinafter sometimes referred to as urethane resin film) combines strength and flexibility and exhibits high elasticity because of the micro phase separation structure of these hard and soft segments. Such characteristics of urethane resin film are closely associated with scratch resistance of an image.

The inventors first studied various urethane resins to improve the scratch resistance of images recorded with pigment ink. As a result, it was found that adding urethane resin to ink admittedly improves the scratch resistance of recorded images but reduces the intermittent ejection stability of the ink. Thus the inventors studied enhancing the hydrophilicity of urethane resin by increasing the acid value with the intention of improving the intermittent ejection stability of ink. As a result, it was found that increasing the acid value of urethane resin admittedly improves the intermittent ejection stability of the ink but reduces the scratch resistance of images. Furthermore, some forms of urethane resin in ink reduced the intermittent ejection stability of the ink.

As mentioned above, urethane resin is mainly composed of polyisocyanate and a component that reacts with it. Increasing the acid value of urethane resin to improve the intermittent ejection stability of ink means increasing the proportion of a unit derived from a short-chain polyol, such as an acid-group-containing diol. Inevitably, the proportion of the unit derived from a long-chain polyol, which is a component intended to react with polyisocyanate like the short-chain polyol, is reduced. This increases the number of urethane bonds and reduces the soft segment in the urethane resin, affecting the flexibility of urethane resin film. Enhancing the hydrophilicity of urethane resin by increasing the acid value therefore improves the intermittent ejection stability of the ink but leads to reduced scratch resistance of images. The reason why images recorded with the ink according to Japanese Patent Laid-Open No. 2013-035897 have low scratch resistance is a high acid value.

Thus the inventors conducted studies on the approach of attaining both intermittent ejection stability of ink and scratch resistance of images while maintaining a low acid value, rather than the approach of enhancing the hydrophilicity of urethane resin by increasing the acid value. More specifically, the inventors conducted detailed studies on the composition of urethane resin on condition that the acid value of the urethane resin should be as low as less than 10 mg KOH/g. As a result, it was found that a unit derived from a certain polyfunctional polyisocyanate can be effectively used as a polyisocyanate-derived unit of urethane resin. In addition to this, with regard to the mode of dispersion of pigment, it is needed to use a self-dispersible pigment or a resin-dispersed pigment using a resin different from the urethane resin.

A polyfunctional polyisocyanate used in certain aspects of the invention is a compound that has two molecules or more of a polyisocyanate-derived structure and a particular structure (described hereinafter). This compound has many branches in the molecule. A urethane resin that has a unit derived from such a polyfunctional polyisocyanate has a three-dimensional structure in which molecular chains are complicatedly entangled and also contains densely packed urethane bonds. This type of urethane resin is therefore superior in strength, which is a weakness of known low-acid-value urethane resins, despite the low acid value. Furthermore, the densely packed urethane bonds make the urethane resin likely to strongly interact with the anionic group that contributes to the dispersion of the pigment through the formation of hydrogen bonds. Even after the ink is applied to a record medium, the urethane resin and the pigment are close to each other owing to the interaction, allowing the urethane resin to stay near the pigment. This appears to be the reason why the scratch resistance of images was improved.

In general, a decrease in intermittent ejection stability occurs because of the evaporation of water out of nozzles of a recording head. For the intermittent ejection stability to be enhanced, it is important that the pigment do not aggregate and remain dispersed in a stable manner even after some amount of water has evaporated out of ink existing near the nozzles of the recording head and the interaction between the urethane resin and the pigment has strengthened. As mentioned above, a urethane resin used in an ink according to an aspect of the invention, although with a low acid value, has a three-dimensional structure in which molecular chains are complicatedly entangled and also contains densely packed urethane bonds because the resin has a unit derived from a polyfunctional polyisocyanate. The urethane resin therefore is likely to take a particulate form once some amount of water evaporates, incorporating the densely packed urethane bonds as a core. After the evaporation of water has further proceeded and the interaction between the urethane resin and the pigment has strengthened, repulsion due to an electrostatic action, repulsive force, and so forth occurs between the urethane resin and the pigment as a result of the urethane resin taking this particulate form. The urethane resin and the pigment therefore interact but do not come too close to each other. These are the reasons why a urethane resin used in certain aspects of the invention improves the scratch resistance of images and enhances the intermittent ejection stability by helping the pigment to maintain a stable dispersion state.

When urethane resin is used to disperse pigment, repulsion between the urethane resin and the pigment would make the resin, which is originally intended to contribute to dispersion, away from the pigment that should be dispersed. This quickly destabilizes the dispersion state of the pigment because some amount of water has already been lost. Furthermore, the urethane resin becomes more likely to interact with itself as the urethane resin gets separated from the pigment. As a result, the ink quickly thickens involving both the pigment and the urethane resin and loses intermittent ejection stability. It is thus needed to select an appropriate mode of pigment dispersion so that the pigment should maintain a stable dispersion state even after some amount of water evaporates. For this reason, a self-dispersible pigment or a resin-dispersed pigment using a resin different from the urethane resin is used in certain aspects of the invention.

As can be understood from the above description, the reason why the ink according to Japanese Patent Laid-Open No. 2006-022132 has low intermittent ejection stability is the use of urethane resin to disperse the pigment. The reason why images recorded with the ink according to Japanese Patent Laid-Open No. 2006-022132 have low scratch resistance is as follows. In this ink a pigment that has no anionic group is dispersed by the urethane resin and thus the urethane resin and the pigment are unlikely to interact with each other. This means that after the ink is applied to a record medium, the urethane resin permeates together with liquid components and cannot stay near the pigment.

The reason why the ink according to Japanese Patent Laid-Open No. 2012-140602 has low intermittent ejection stability is that although this ink contains a polyfunctional polyisocyanate that has an allophanate structure, this allophanate structure has added a polyethylene glycol monomethyl ether with a large number-average molecular weight. A urethane resin that has a unit derived from such a polyfunctional polyisocyanate has many ethylene oxide chains. In this case it is likely that hydrogen bonds formed between the ethylene oxide chains in conjunction with the evaporation of water quickly increases the viscosity of the ink.

The reason why images recorded with the ink according to Japanese Patent Laid-Open No. 2012-140602 have low scratch resistance is also the addition of a polyethylene glycol with a large number-average molecular weight to an allophanate structure. Urethane bonds in a urethane resin that has a unit derived from such a polyfunctional polyisocyanate are unlikely to come close to each other because highly hydrophilic polyethylene glycol chains are present very near the urethane bonds. In this case the anionic group of the pigment and the urethane bonds are not likely to form hydrogen bonds and thus the urethane resin and the pigment are unlikely to interact with each other. This means that after the ink is applied to a record medium, the urethane resin permeates together with liquid components and cannot stay near the pigment.

### Ink

The following describes in detail the individual components of an ink for ink jet according to an embodiment of the invention.

### Urethane Resin

A urethane resin contained in an ink according to an embodiment of the invention has a unit derived from a polyfunctional polyisocyanate (described hereinafter) and an acid value of less than 10 mg KOH/g. The upper limit of the acid value of the urethane resin can be 9 mg KOH/g or less. The lower limit of the acid value is 0 or more. This means that the urethane resin does not necessarily have a unit that provides an acid value.

The urethane resin content (% by mass) of the ink can be 0.15% by mass or more and 30.0% by mass or less, preferably 1.0% by mass or more and 20.0% by mass or less, based on the total mass of the ink. The mass ratio of the urethane resin content (% by mass) to the pigment content (% by mass) based on the total mass of the ink can be 0.05 times or more and 10.0 times or less. Making this mass ratio less than 0.05 times can cause the scratch resistance of images to be insufficient. Making this mass ratio more than 10.0 times can cause the intermittent ejection stability to be insufficient.

The polyfunctional polyisocyanate-derived unit of the urethane resin efficiently works particularly when the urethane resin is neither one that contains acrylic resin chains (a urethane-acrylic resin) nor one that cures upon exposure to active energy radiation, i.e., a urethane resin that has a polymerizable group.

### Polyfunctional Polyisocyanate

The term “polyfunctional polyisocyanate” as used herein refers to a compound that has two molecules or more of a polyisocyanate-derived structure and a particular structure described below and contains two or more terminal isocyanate groups for reaction with a reaction partner, such as a polyol or a polyamine. The particular structure is at least one structure selected from the group consisting of (a) an allophanate structure that has added a monohydric alcohol containing 1 to 5 carbon atoms, (b) a uretdione structure, (c) an isocyanurate structure, and (d) a biuret structure.

The following describes the structures (a) to (d). In the structural formulae R₁ represents the residue of the polyisocyanate, i.e., the structure excluding NCO, and multiple R₁s in one molecule may be the same or different.

A polyfunctional polyisocyanate that has (a) an allophanate structure that has added a monohydric alcohol containing 1 to 5 carbon atoms is formed by the addition of an isocyanate to a urethane bond. Formula (a) illustrates an allophanate structure in the portion enclosed by a broken line, where R₂ represents an alkyl group containing 1 to 5 carbon atoms. R₂ is the residue of the monohydric alcohol used to form the urethane bond. Examples of monohydric alcohols include methanol, ethanol, propanol, butanol, and pentanol. In particular, it is preferred to use a monohydric alcohol that has a terminal hydroxy group on an alkyl group, a monohydric alcohol that has a linear alkyl group, or a monohydric alcohol that has an alkyl group containing 3 to 5 carbon atoms.

A polyfunctional polyisocyanate that has (b) a uretdione structure is formed by the dimerization of an isocyanate. Formula (b) illustrates a uretdione structure in the portion enclosed by a broken line.

A polyfunctional polyisocyanate that has (c) an isocyanurate structure is formed by the trimerization of an isocyanate. Formula (c) illustrates an isocyanurate structure in the portion enclosed by a broken line.

A polyfunctional polyisocyanate that has (d) a biuret structure is formed by the addition of an isocyanate to a urea bond. Formula (d) illustrates a biuret structure in the portion enclosed by a broken line.

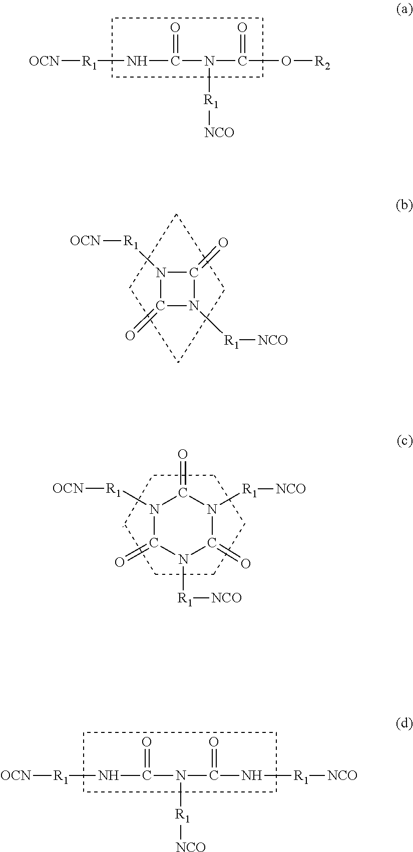

Examples of polyisocyanates that can be used as a component of the polyfunctional polyisocyanate include aliphatic or aromatic polyisocyanates.

Examples of aliphatic polyisocyanates include: polyisocyanates that have a chain structure, such as tetramethylene diisocyanate, hexamethylene diisocyanate, dodecamethylene diisocyanate, 2,2,4-trimethylhexamethylene diisocyanate, 2,4,4-trimethylhexamethylene diisocyanate, lysine diisocyanate, 2-methylpentane-1,5-diisocyanate, and 3-methyl-1,5-pentane diisocyanate; and polyisocyanates that have a ring structure, such as isophorone diisocyanate, hydrogenated xylylene diisocyanate, 4,4′-dicyclohexylmethane diisocyanate, 1,4-cyclohexane diisocyanate, methyl cyclohexylene diisocyanate, and 1,3-bis(isocyanate methyl)cyclohexane.

Examples of aromatic polyisocyanates include tolylene diisocyanate, 2,2′-diphenylmethane diisocyanate, 2,4-diphenylmethane diisocyanate, 4,4′-diphenylmethane diisocyanate, 4,4′-dibenzyl diisocyanate, 1,5-naphthylene diisocyanate, xylylene diisocyanate, 1,3-phenylene diisocyanate, 1,4-phenylene diisocyanate, dialkyldiphenylmethane diisocyanate, tetraalkyldiphenylmethane diisocyanate, and α,α,α,α-tetramethylxylylene diisocyanate.

In particular, it is preferred that the polyisocyanate be an aliphatic polyisocyanate, more preferably hexamethylene diisocyanate. An allophanate structure that has added a monohydric alcohol containing 1 to 5 carbon atoms, a uretdione structure, and a biuret structure are preferred to other structures that can be used for the polyfunctional polyisocyanate. In particular, an allophanate structure that has added a monohydric alcohol containing 1 to 5 carbon atoms is more preferred than others. In an embodiment of the invention it is particularly preferred to use a hexamethylene diisocyanate that has an allophanate structure that has added a monohydric alcohol containing 1 to 5 carbon atoms. An allophanate structure contributes to improved strength of urethane resin film because of its three-dimensional structure and branched structure, and hexamethylene diisocyanate contributes to improved flexibility of urethane resin film because it is a linear chain. The use of a hexamethylene diisocyanate that has an allophanate structure that has added a monohydric alcohol containing 1 to 5 carbon atoms therefore provides recorded images with particularly high scratch resistance resulting from excellent strength and flexibility of urethane resin film.

### Polyol or Polyamine

Examples of components that provide a unit that reacts with the polyfunctional polyisocyanate to form the urethane resin include polyols and polyamines. A single polyol or polyamine can be used alone, and it is also possible to use two or more polyols and/or polyamines if necessary.

Examples of polyols include the following: long-chain polyols such as polyester polyols, polycarbonate polyols, and polyether polyols; and short-chain polyols such as acid-group-containing diols.

Examples of polyester polyols include acid esters. Examples of acid components of acid esters include the following: aromatic dicarboxylic acids such as phthalic acid, naphthalene dicarboxylic acid, biphenyl dicarboxylic acid, and tetrahydrophthalic acid; alicyclic dicarboxylic acids such as hydrogenated forms of such aromatic dicarboxylic acids; and aliphatic dicarboxylic acids such as malonic acid, succinic acid, tartaric acid, oxalic acid, glutaric acid, adipic acid, pimelic acid, suberic acid, azelaic acid, sebacic acid, alkyl succinic acids, linolenic acid, maleic acid, fumaric acid, mesaconic acid, citraconic acid, and itaconic acid. Other forms of such acid components, such as anhydrides, salts, and derivatives (alkyl esters and acid halides), can also be used as an acid component.

Examples of components that form an ester with an acid component include polyols such as diols and triols and glycols such as (poly)alkylene glycols. Examples of polyols include the following: diols such as 1,3-propanediol, 1,3-butanediol, 1,4-butanediol, 1,5-pentanediol, 1,6-hexanediol, 3-methyl-1,5-pentanediol, 2-butyl-2-ethyl-1,3-propanediol, 1,4-cyclohexanediol, 1,4-cyclohexanedimethanol, 4,4-dihydroxyphenyl propane, 4,4-dihydroxyphenyl methane, hydrogenated bisphenol A, and dimethylolurea and its derivatives; triols such as glycerin, trimethylolpropane, 1,2,5-hexanetriol, 1,2,6-hexanetriol, pentaerythritol, trimethylolmelamine and its derivatives, and polyoxypropylenetriol. Examples of glycols include the following: polyalkylene glycols such as hexamethylene glycol, tetramethylene glycol, ethylene glycol, diethylene glycol, triethylene glycol, tetraethylene glycol, polyethylene glycol, propylene glycol, dipropylene glycol, tripropylene glycol, polypropylene glycol, (poly)tetramethylene glycol, and neopentylglycol; and ethylene glycol-propylene glycol copolymers.

Examples of polycarbonate polyols that can be used include those produced by known processes. Examples of such polycarbonate polyols include alkanediol-based polycarbonate diols, such as polyhexamethylene carbonate diol. Other examples include polycarbonate diols obtained through the reaction between a carbonate component or phosgene and an aliphatic diol component. Examples of carbonate components include alkylene carbonates, diaryl carbonates, and dialkyl carbonates.

Examples of polyether polyols include alkylene oxide-polyol addition polymers and (poly)alkylene glycols. Examples of alkylene oxides include ethylene oxide, propylene oxide, butylene oxide, and α-olefin oxide. Examples of polyols that undergo addition polymerization with an alkylene oxide include those listed above as examples of components of polyester polyols. Examples of (poly)alkylene glycols include those listed above as examples of components of polyester polyols.

The number-average molecular weight of a long-chain polyol, such as polyester polyol, polycarbonate polyol, or polyether polyol, can be 450 or more and 4,000 or less. Reducing the number-average molecular weight of a long-chain polyol often enhances the strength of urethane resin film because of an increased number of urethane bonds and increased stiffness of the polyol. Increasing the number-average molecular weight of a long-chain polyol that reacts with the polyisocyanate often enhances the flexibility of urethane resin film because of a reduced number of urethane bonds and increased stretchability of the polyol. Ensuring that the number-average molecular weight of a long-chain polyol is 450 or more and 4,000 or less therefore provides recorded images with particularly high scratch resistance as a result of a good balance between the strength and flexibility of urethane resin film. Making the number-average molecular weight of a long-chain polyol less than 450 can cause the scratch resistance to be insufficient because in such a case urethane resin film would be rigid and brittle. Making the number-average molecular weight of a long-chain polyol more than 4,000 can also cause the scratch resistance to be insufficient because in such a case urethane resin film would be too flexible.

Examples of acid group-containing diols, i.e., specific examples of short-chain polyols, include dimethylolacetic acid, dimethylolpropionic acid, dimethylolbutanoic acid, and dimethylolbutyric acid. In particular, dimethylolpropionic acid and dimethylolbutanoic acid are preferred. In an embodiment of the invention the urethane resin may have an acid group that contains a carboxylic acid group. The acid group of an acid group-containing diol may be in the form of salt. Examples of cations with which such a salt is formed include ions of alkali metals such as lithium, sodium, and potassium, ammonium ion, and cations of organic amines such as dimethylamine. In an embodiment of the invention, in which the acid value of the urethane resin is less than 10 mg KOH/g, an example of a possible way to adjust the acid value of the urethane resin is to use an appropriate amount of an acid group-containing diol. Making the acid value of the urethane resin 10 mg KOH/g or more causes a lack of scratch resistance.

Other polyols can also be used, including polyhydroxy polyacetal, polyhydroxy polyacrylate, polyhydroxy polyester amide, and polyhydroxy polythioether.

Examples of polyamines include ethylenediamine, propylenediamine, diethylenetriamine, hexylenediamine, triethylenetetramine, tetraethylenepentamine, isophoronediamine, xylylenediamine, diphenylmethanediamine, hydrogenated diphenylmethanediamine, hydrazine, polyamide polyamines, and polyethylene polyimines. Commonly used polyamine compounds basically serve as a hard segment of urethane resin because most of them have a molecular weight similar to that of short-chain polyols.

In particular, it is preferred to use a polyol, more preferably a polyether polyol, because this ensures an excellent balance between the strength and flexibility of urethane resin film. A particularly preferred polyether polyol is polypropylene glycol. This is because of the following reasons. Polypropylene glycol is composed of units each containing more carbon atoms than polyethylene glycol and less than polytetramethylene glycol. Urethane resin film obtained with the use of polypropylene glycol therefore has characteristics roughly intermediate between those with the other two glycols. As a result, urethane resin film obtained with the use of polypropylene glycol has a good balance between strength and flexibility, with both qualities better than with the other two glycols. Furthermore, polypropylene glycol has a structure in which methyl groups are branches, and this structure promotes interaction with the pigment. This helps the urethane resin to stay near the pigment after the ink is applied to a record medium. These are the reasons why the use of polypropylene glycol provided recorded image with particularly high scratch resistance.

### Cross-Linking Agent or Chain Extender

The urethane resin may contain a cross-linking agent or a chain extender. Usually, a cross-linking agent is used during the synthesis of a prepolymer, and a chain extender is used during chain-extending reaction that follows the synthesis of a prepolymer. Such a cross-linking agent or a chain extender can basically be one selected from substances such as the above-listed polyisocyanates, polyols, and polyamines as deemed appropriate for the intended application, e.g., cross-linking or chain extension. A chain extender can also be an agent that allows the urethane resin to form crosslinks.

The urethane resin may have crosslinks. For example, a urethane resin synthesized with the use of a trifunctional cross-linking agent has three urethane bonds per molecule of the cross-linking agent. Crosslinking the urethane resin thus increases the hard segment, thereby helping the resin to form the aforementioned micro phase separation structure and enhancing the strength of urethane resin film. The density of urethane bonds is also increased, helping the urethane bonds to form hydrogen bonds with each other. The accordingly increased density of the hard segment helps the resin to form an island-sea micro phase separation structure, enhancing the flexibility of urethane resin film. For these reasons, crosslinking the urethane resin enhances the strength and flexibility of urethane resin film in a balanced manner and thereby provides recorded images with particularly high scratch resistance.

An example of a way to crosslink the urethane resin is to use a compound that has three or more functional groups as a cross-linking agent during the synthesis of the urethane resin. Examples of compounds that have three or more functional groups and can be used as a cross-linking agent include the following: polyfunctional polyisocyanates that have three or more functional groups; polyols that have three or more functional groups; and polyamines that have three or more functional groups. Examples of polyfunctional polyisocyanates that have three or more functional groups include polyfunctional polyisocyanates that have an isocyanurate structure and polyfunctional polyisocyanates that have a biuret structure. Examples of preferred cross-linking agents include glycerin, trimethylolpropane, pentaerythritol, and polyoxypropylenetriol.

Research by the inventors revealed that it is possible to determine whether a urethane resin has crosslinks according to “the gel fraction,” a value calculated taking advantage of the phenomenon of a urethane resin that has a cross-linked structure being sparingly soluble. The gel fraction of urethane resin is determined by the calculation of the mass ratio (% by mass) of gel to the total mass of the urethane resin of interest, where the “gel” is defined as the component of the urethane resin that remains undissolved when the resin is dissolved in a particular organic solvent. The gel fraction is therefore a measure of the “degree of crosslinking” determined from the solubility of film made from the urethane resin, and the gel fraction increases with increasing degree of crosslinking. In an embodiment of the invention, the urethane resin is deemed to have crosslinks if the gel fraction is 88% by mass or more as measured by the method described hereinafter. The upper limit of the gel fraction is 100% by mass or less.

A chain extender is a compound used as a reaction partner for the isocyanate groups of a fraction of the prepolymer polyisocyanate that has not formed urethane bonds. Examples of compounds that can be used as a chain extender include the following: glycols; polyols; and polyamines. Examples of preferred chain extenders include ethylenediamine, diethylenetriamine, and triethylenetetramine.

### Molar Ratio of Urethane Bonds/Urea Bonds

The molar ratio of the proportion (% by mole) of urethane bonds in the urethane resin to the proportion (% by mole) of urea bonds is preferably 85.0/15.0 or more, more preferably 90.0/10.0 or more. Ensuring that the molar ratio of urethane bonds/urea bonds is in these ranges enhances the intermittent ejection stability. The upper limit of this molar ratio can be 98.5/1.5 or less. This molar ratio is a fractional representation of the proportion (% by mole) of urethane bonds and that of urea bonds (% by mole) in the urethane resin with the total as 100.0% by mole. For example, a molar ratio of 85.0/15.0 or more means that the proportion of urethane bonds is 85.0% by mole or more. In this case therefore the proportion of urea bonds is 15.0% by mole or less (equal to or less than the result of a subtraction of 85.0% by mole for urethane bonds from the total of 100.0% by mole).

Examples of ways to adjust the molar ratio of urethane bonds/urea bonds of the urethane resin include the following two methods. The first method is the adjustment of the amount of an amine compound used during the synthesis of the urethane resin. In this method, the amount of formation of urea bonds through the reaction between the amine compound and isocyanate groups is controlled. A detailed description of a process for synthesizing the urethane resin is as follows. First, multiple urethane resins are synthesized with different amounts of an amine compound, and the molar ratios of urethane bonds/urea bonds are calculated by the method described hereinafter. The obtained molar ratios are used to explore the relationship between the amount of use of the amine compound and the molar ratio and create a calibration curve. This calibration curve is used to determine the amount of the amine compound required to synthesize a urethane resin that has the desired molar ratio. A calibration curve is created first because the use of a given amine compound does not always result in the same molar ratio because the rate of reaction and other conditions may vary depending on the kinds of the other components.

The second method is to adjust the proportion of unreacted isocyanate groups during the phase inversion of the urethane resin to water. In this method, the amount of formation of urea bonds through the reaction between water and isocyanate groups is controlled. A detailed description of a process for synthesizing the urethane resin is as follows. The proportion of unreacted isocyanate groups based on the amount of polyisocyanate used is monitored with a Fourier transform infrared spectrophotometer (FT-IR) during the reaction for synthesizing the urethane resin. The proportion of unreacted isocyanate groups can be adjusted by changing parameters such as the duration of reaction and the amount of use of polyisocyanate. Ion-exchanged water is added to the reaction system when the proportion of unreacted isocyanate groups matches the desired molar ratio of urethane bonds/urea bonds. For example, in a case where a urethane resin is synthesized in which the molar ratio of urethane bonds/urea bonds is 95.0/5.0, ion-exchanged water is added when the proportion of unreacted isocyanate groups derived from the loaded polyisocyanate is 5.0% by mole. In the Examples, this second method was used to adjust the molar ratio of urethane bonds/urea bonds of urethane resins.

Polyamines can be used as a reaction partner for the polyfunctional polyisocyanate, a chain extender, a cross-linking agent, and so forth. However, reaction between isocyanate groups and an amine forms urea bonds. When a polyamine is used, the amount of use of the amine can be such that the urethane resin can have the desired molar ratio of urethane bonds/urea bonds.

### Process of Synthesis

Processes that have been commonly used to synthesize urethane resin can all be used to synthesize a urethane resin for an ink according to an embodiment of the invention. An example is the following process. A prepolymer that has terminal isocyanate groups is synthesized through the reaction between a polyfunctional polyisocyanate and its reaction partner (a polyol or a polyamine). The amounts of use of the two materials are such that isocyanate groups should be large in number. An organic solvent that has a boiling point of 100° C. or lower may be optionally used. If an acid-group-containing diol is used as a raw material, the acid group of the prepolymer is neutralized with a neutralizing agent. The prepolymer is then added to a liquid that contains a chain extender or a cross-linking agent for chain-extending reaction or crosslinking reaction. Then the organic solvent is removed if used. In this way, urethane resin is obtained.

Examples of neutralizing agents include the following: organic bases such as N,N-dimethylethanolamine, N,N-diethylethanolamine, diethanolamine, triethanolamine, trimethylamine, and triethylamine; and inorganic bases such as sodium hydroxide, potassium hydroxide, and ammonia. The amount of neutralizing agent used is preferably from 0.5 to 1.0 mole, more preferably from 0.8 to 1.0 mole, per mole of acidic groups of the prepolymer. If not, reduced stability or increased viscosity of the liquid that contains the urethane resin may slightly affect the operations for the preparation of the ink. Furthermore, research by the inventors revealed that the use of an alkali-metal containing neutralizing agent enhances the intermittent ejection stability of the ink compared to the use of an amine or any other organic base. It is preferred to use an alkali-metal-containing neutralizing agent, such as sodium hydroxide or potassium hydroxide, because this provides the ink with high intermittent ejection stability.

### Analysis of the Urethane Resin

(1) The composition, (2) the structure of the polyfunctional polyisocyanate, (3) the acid value, (4) the gel fraction, and (5) the molar ratio of urethane bonds/urea bonds can be individually analyzed by the methods described below. A method for extracting the urethane resin from an ink that contains the urethane resin and pigment is first described. Specifically, the urethane resin can be extracted by precipitation through the addition of an excess of acid (e.g., hydrochloric acid) to a supernatant collected after centrifugation of the ink at 80,000 rpm. The urethane resin can also be extracted from the ink with the use of an organic solvent that does not dissolve the pigment but dissolves the urethane resin (e.g., hexane). Although the following analyses can be done on the ink, the use of urethane resin (solid) extracted by this method allows for more accurate analyses.

### Composition of the Urethane Resin

The positions of the peaks obtained by a proton nuclear magnetic resonance (¹H-NMR) analysis of a solution of the urethane resin in deuterated dimethyl sulfoxide can be used to confirm the identity of the components, i.e., a polyisocyanate, a polyol or a polyamine, and so forth. It is also possible to calculate the composition ratio from the proportions of the integrated peak intensities corresponding to the chemical shifts of the individual components. Analysis of the urethane resin by pyrolysis gas chromatography also provides the identity of the components, i.e., a polyisocyanate, a polyol or a polyamine, and so forth. Furthermore, it is possible to calculate the number-average molecular weight from the number of repetition of units in a long-chain polyol determined through analysis by carbon nuclear magnetic resonance spectroscopy (¹³C-NMR).

### (2) Structure of the Polyfunctional Polyisocyanate

An infrared (IR) absorption spectrum obtained by an IR spectroscopic analysis of the urethane resin can be used to confirm the structure of the polyfunctional polyisocyanate. Major absorption bands are as follows: allophanate structure, NH stretching vibration absorption at 3300 cm⁻¹ and two C═O stretching vibration absorption bands at 1750 to 1710 cm⁻¹ and 1708 to 1653 cm⁻¹; uretdione structure, C═O stretching vibration absorption at 1780 to 1755 cm⁻¹ and uretdione-ring absorption at 1420 to 1400 cm⁻¹; isocyanurate structure, C═O stretching vibration absorption at 1720 to 1690 cm⁻¹ and isocyanurate-ring absorption at 1428 to 1406 cm⁻¹; biuret structure, C═O stretching vibration absorption at 1720 to 1690 cm⁻¹.

### (3) Acid Value of the Urethane Resin

The acid value of the urethane resin can be measured by titration. In the Examples, the acid value of urethane resins dissolved in tetrahydrofuran was measured by potentiometric colloidal titration with the use of an automatic potentiometric titrator (trade name, AT-510; Kyoto Electronics Manufacturing) equipped with a stream potential titration unit (PCD-500). A solution of potassium hydroxide in ethanol was used as titrant.

### (4) Gel Fraction

The urethane resin is added to water to form a solution that contains the urethane resin. This solution is used to form a coating of urethane resin that is of uniform thickness (mass B). This coating is placed in an environment at a temperature of 23° C. for 24 hours in tetrahydrofuran. Then the mass A of the component that remains undissolved (gel) is used to calculate the gel fraction (A/B×100%).

### (5) Molar Ratio of Urethane Bonds/Urea Bonds

The molar ratio of urethane bonds/urea bonds of the urethane resin can be determined from the ratio between the integrated intensities of the peaks corresponding to the urethane bond and the urea bond obtained by a carbon nuclear magnetic resonance spectroscopic analysis (¹³C-NMR) of a solution of the urethane resin in deuterated dimethyl sulfoxide. It should be noted that the positions of the peaks corresponding to the urethane bond and the urea bond may vary with the kinds of the compounds used to synthesize the urethane resin. It is therefore needed to locate the peaks corresponding to the urethane bond and the urea bond specific to the compounds used to synthesize the urethane resin. The following describes a method for this.

First, the composition of the urethane resin, or more specifically the polyisocyanate and its reaction partner (a polyol or a polyamine), is analyzed by methods (1) and (2). Then the chemical shifts of the urethane bond and the urea bond specific to the polyisocyanate are determined by the following procedure. Reaction products are prepared with the use of the polyisocyanate and each of its potential reaction partners (a long-chain polyol, an acid-group-containing diol, a polyamine, and water). For example, when a combination of a long-chain polyol and an acid-group-containing diol is used, the following materials are individually prepared: (i) the reaction product of the polyisocyanate and the long-chain polyol, (ii) the reaction product of the polyisocyanate and the acid-group-containing diol, and (iii) the reaction product of the polyisocyanate and water. The prepared reaction products are dissolved in deuterated dimethyl sulfoxide, and the solutions are analyzed by carbon nuclear magnetic resonance spectroscopy (¹³C-NMR) for the chemical shifts of the urethane bond and the urea bond in each reaction product. In the above example, reaction products (i) and (ii) are used to determine the chemical shift of the urethane bond, and reaction product (iii) is used to determine the chemical shift of the urea bond. The obtained chemical shifts are used to identify the peaks corresponding to the urethane bond and the urea bond. The ratio between the integrated intensities of these peaks is used to calculate the molar ratio of urethane bonds/urea bonds of the urethane resin.

### Pigment

A coloring material used in an ink according to an embodiment of the invention is at least one of a pigment the particles of which have an anionic group bonded to their surface directly or via another atomic group and a pigment dispersed by a resin having an anionic unit and different from the urethane resin. Examples of pigments that can be used include the following: inorganic pigments such as carbon black, calcium carbonate, and titanium oxide; and organic pigments such as azo, phthalocyanine, and quinacridone. It is possible to use materials such as dye in addition to the pigment for purposes such as color control. The pigment content (% by mass) of the ink is preferably 0.1% by mass or more and 15.0% by mass or less, more preferably 1.0% by mass or more and 10.0% by mass or less, based on the total mass of the ink.

Examples of pigments the particles of which have an anionic group bonded to their surface directly or via another atomic group include ones the particles of which a functional group containing an anionic group is bonded to and ones the particles of which an anionic resin is bonded to. Examples of pigments dispersed by a resin having an anionic unit and different from the urethane resin include ones the particles of which an anionic resin is physically adsorbed to and pigments encapsulated by an anionic resin. Naturally, a combination of multiple pigments with different modes of dispersion can also be used. In particular, it is preferred to use a self-dispersible pigment the particles of which a functional group containing an anionic group or an anionic resin are bonded, or a resin-dispersed pigment the particles of which an anionic resin dispersant is physically adsorbed to their surface.

A self-dispersible pigment the particles of which a functional group containing an anionic group is bonded to includes an anionic group such as —COOM, —SO₃M, —PO₃HM, or —PO₃M₂ bonded to the surface of pigment particle directly or via another atomic group (—R—). Examples of Ms include the following: a hydrogen atom; alkali metals such as lithium, sodium, and potassium; ammonium (NH₄); and organic ammoniums such as methylamine, ethylamine, monoethanolamine, diethanolamine, and triethanolamine. Examples of the “another atomic group (—R—)” include the following: linear or branched alkylene groups that contain 1 to 12 carbon atoms; arylene groups such as a phenylene group and a naphthylene group; an amide group; a sulfonyl group; an amino group; a carbonyl group; an ester group; an ether group; and combinations of such groups. Examples of self-dispersible pigments of this type that can be used include ones obtained by oxidation wherein an anionic group is bonded to the surface of the pigment particle and ones obtained by known processes such as diazo coupling wherein a functional group containing an anionic group is bound to the surface of the pigment particle.

A self-dispersible pigment the particles of which an anionic resin is bonded to (a resin-bonded self-dispersible pigment) includes a resin that is a (co)polymer having at least an anionic-group-containing unit as a hydrophilic unit and is bonded to the surface of the pigment particle directly or via another atomic group (—R—). Examples of resins that can be used are similar to those listed below as examples of resin dispersants for a resin-dispersed pigment. Examples of the “another atomic group (—R—)” are similar to those listed above.

A resin-dispersed pigment the particles of which an anionic resin is physically adsorbed to and a resin-dispersed pigment obtained by the encapsulation of pigment with an anionic resin are both dispersed by a resin dispersant. A copolymer that has a hydrophilic unit (including at least a unit that has an anionic group) and a hydrophobic unit is used as a resin dispersant. In general, the former resin-dispersed pigment is prepared through the application of shear force to a mixture of pigment and a resin dispersant, and the latter resin-dispersed pigment is prepared through the covering of at least a portion of the surface of pigment particles with a resin dispersant by coacervation, acid precipitation, or a similar process.

A resin dispersant for a resin-bonded self-dispersible pigment or a resin-dispersed pigment can be any known (co)polymer for inks for ink jet. It is necessary that such a resin dispersant be different from the urethane resin. Examples of resin dispersants that can be used include copolymers that have a hydrophilic unit and a hydrophobic unit examples of which are listed below (e.g., acrylic resin). The hydrophilic unit should include at least a unit that has an anionic group. Examples of hydrophilic units include units derived from hydrophilic monomers such as (meth)acrylic acid and its salts. Examples of hydrophobic units include the following: units derived from hydrophobic monomers that have an aromatic ring, such as styrene, its derivatives, and benzyl (meth)acrylate; and units derived from hydrophobic monomers such as (meth)acrylates and other monomers with an aliphatic group.

Examples of resins that can be used as a resin dispersant include ones whose weight-average molecular weight is 1,000 or more and 30,000 or less, in particular 3,000 or more and 15,000 or less, and ones whose acid value is 80 mg KOH/g or more and 250 mg KOH/g or less. In an embodiment of the invention, a (meth)acrylic resin whose acid value is 80 mg KOH/g or more and 250 mg KOH/g or less can be used as a resin dispersant. When a mode of dispersion that involves a resin dispersant is used, it is preferred that the mass ratio of resin dispersant/pigment be 0.1 times or more and 10.0 times or less, more preferably 0.5 times or more and 5.0 times or less.

### Aqueous Medium

An ink according to an embodiment of the invention may contain water or an aqueous medium that is a mixture of water and a water-soluble organic solvent. In an embodiment of the invention, the ink can be an aqueous ink that contains at least water as an aqueous medium. The water can be deionized water (ion-exchanged water). The water content (% by mass) of such an ink is preferably 10.0% by mass or more and 90.0% by mass or less, more preferably 50.0% by mass or more and 90.0% by mass or less, based on the total mass of the ink.

A water-soluble organic solvent can be of any kind of solvent that is soluble in water. Examples of water-soluble organic solvents that can be used include monohydric or polyhydric alcohols, (poly)alkylene glycol, glycol ether, nitrogen-containing polar solvents, and sulfur-containing polar solvents. The water-soluble organic solvent content (% by mass) of an ink can be 3.0% by mass or more and 50.0% by mass or less based on the total mass of the ink.

### Other Additives

An ink according to an embodiment of the invention may optionally contain water-soluble organic compounds that are solid at normal temperature, including polyhydric alcohols such as trimethylolpropane and trimethylolethane; urea; and urea derivatives such as ethyleneurea; in addition to the components described above. An ink according to an embodiment of the invention may optionally contain additives such as surfactants, pH adjusters, antirusts, preservatives, antimolds, antioxidants, reduction inhibitors, evaporation promoters, chelating agents, and water-soluble resins. An ink according to an embodiment of the invention can be a non-curable ink, i.e., an ink that contains no resin that polymerizes upon exposure to active energy radiation.

### Ink Cartridge

An ink cartridge according to an embodiment of the invention has ink and an ink storage portion that stores the ink. The ink to be stored in the ink storage portion is an ink according to an embodiment of the invention described above. An illustrative structure of the ink cartridge has a chamber for a negative pressure generator that stays impregnated with the ink taking advantage of negative pressure (a negative pressure generator storing chamber) and an ink chamber in which the ink is stored not retained in the negative pressure generator. In a possible structure the ink storage portion may have no ink chamber and have a negative pressure generator impregnated with all of the ink, and in another possible structure the ink storage portion may have no negative pressure generator and store all of the ink without impregnation in a negative pressure generator. The ink cartridge can also be one that has an ink storage portion and a recording head.

### Ink Jet Recording Method

An ink jet recording method according to an embodiment of the invention includes ejecting an ink according to an embodiment of the invention described above from an ink jet recording head to record an image on a record medium. Examples of modes of ejection of the ink include one in which mechanical energy is applied to the ink and one in which thermal energy is applied to the ink. In an embodiment of the invention, it is particularly preferred to use a mode of ejection in which thermal energy is applied to the ink to eject the ink. Except for the use of an ink according to an embodiment of the invention, operations in the ink jet recording method can be the same as those in known methods.

### EXAMPLES

The following describes certain aspects of the invention in more detail by providing examples and comparative examples. No aspect of the invention is limited to these examples while within the scope of the invention. The terms “parts” and “%” used in relation to the amount of components are based on mass unless otherwise specified.

Abbreviations are as follows: HDI, hexamethylene diisocyanate; IPDI, isophorone diisocyanate; TDI, tolylene diisocyanate; MDI, diphenylmethane diisocyanate; PPG, polypropylene glycol; HMDA, hexamethylenediamine; PE, polyester polyol; PC, polyhexamethylene carbonate diol; PTMG, polytetramethylene glycol; PEG, polyethylene glycol; DMPA, dimethylolpropionic acid; TMP, trimethylolpropane; GLY, glycerin; EDA, ethylenediamine; DETA, diethylenetriamine; TETA, triethylenetetramine; NPG, neopentylglycol.

### Synthesis of Polyfunctional Polyisocyanates

The isocyanate content and the proportion of unreacted isocyanate groups were measured by the methods described in JIS K7301.

### Compound 1

To a reaction vessel equipped with a stirrer, a thermometer, a condenser, and a nitrogen gas introduction tube, 186.0 parts of HDI, 14.0 parts of isopropanol, and 0.1 parts of a tin-based catalyst were added in a nitrogen atmosphere. The reaction was allowed to proceed at a temperature of 80° C. for 2 hours, yielding a reaction liquid that contained a urethane. To the obtained reaction liquid, 0.01 parts of zirconium 2-ethylhexanoate (a catalyst for the formation of an allophanate) was added. The reaction was allowed to proceed at a temperature of 100° C., yielding a reaction liquid. The obtained reaction liquid was distilled with a thin-film evaporator until unreacted HDI was removed, yielding compound 1. The obtained compound 1 was an HDI with an allophanate structure, and its isocyanate content was 20.0%.

### Compound 2

Compound 2 was obtained in the same procedure as in the synthesis of compound 1 except that HDI was changed to 189.2 parts of IPDI and the amount of isopropanol was changed to 10.8 parts. The obtained compound 2 was an IPDI with an allophanate structure, and its isocyanate content was 20.0%.

### Compound 3

Compound 3 was obtained in the same procedure as in the synthesis of compound 1 except that HDI was changed to 186.5 parts of TDI and the amount of isopropanol was changed to 13.5 parts. The obtained compound 3 was a TDI with an allophanate structure, and its isocyanate content was 20.0%.

### Compound 4

Compound 4 was obtained in the same procedure as in the synthesis of compound 1 except that HDI was changed to 190.4 parts of MDI and the amount of isopropanol was changed to 9.6 parts. The obtained compound 4 was a MDI with an allophanate structure, and its isocyanate content was 20.0%.

### Compound 5

To a reaction vessel equipped with a stirrer, a thermometer, a condenser, and a nitrogen gas introduction tube, 200.0 parts of HDI and 260.0 parts of methyl ethyl ketone were added in a nitrogen atmosphere. After dissolution, 0.8 parts of tributylphosphine was added. The reaction was allowed to proceed at a temperature of 25° C. for 24 hours, yielding a reaction liquid. The obtained reaction liquid was distilled with a thin-film evaporator until unreacted HDI was removed, yielding compound 5. The obtained compound 5 was an HDI with a uretdione structure, and its isocyanate content was 20.0%.

### Compound 6

To a reaction vessel equipped with a stirrer, a thermometer, a condenser, and a nitrogen gas introduction tube, 200.0 parts of HDI was added in a nitrogen atmosphere. After the temperature was increased to 60° C., 1.2 parts of a 90.0% solution of potassium 2-ethylhexanoate in diethylene glycol was added. The reaction was allowed to proceed for 2 hours, yielding a reaction liquid. The obtained reaction liquid was distilled with a thin-film evaporator until unreacted HDI was removed, yielding compound 6. The obtained compound 6 was an HDI with an isocyanurate structure, and its isocyanate content was 20.0%.

### Compound 7

To a reaction vessel equipped with a stirrer, a thermometer, a condenser, and a nitrogen gas introduction tube, 192.0 parts of HDI and 0.3 parts of di-n-butyl phosphate were added in a nitrogen atmosphere. The mixture was stirred at a temperature of 250° C. Then 7.8 parts of hexamethylenediamine was continuously fed to the reaction vessel. The reaction was allowed to proceed to completion, yielding a reaction liquid. The obtained reaction liquid was distilled with a thin-film evaporator until unreacted HDI was removed, yielding compound 7. The obtained compound 7 was an HDI with a biuret structure, and its isocyanate content was 20.0%.

### Compound 8

To a reaction vessel equipped with a stirrer, a thermometer, a condenser, and a nitrogen gas introduction tube, 863.0 g of HDI, 137.0 g of polyethylene glycol monomethyl ether (number-average molecular weight: 400), and 0.2 g of zirconium 2-ethylhexanoate were added. The reaction was allowed to proceed at a temperature of 90° C. for 2 hours. Then 0.1 g of phosphoric acid was added. The termination reaction was allowed to proceed at a temperature of 50° C. for 1 hour, yielding a reaction product. The isocyanate content of the reaction product was 40.2%. This reaction product was distilled with a thin-film evaporator at a temperature of 130° C. and a pressure of 0.04 kPa until unreacted HDI was removed, yielding compound 8. The obtained compound 8 was an HDI with an allophanate structure, and its isocyanate content was 11.4%.

### Compound 9

Compound 9 was obtained in the same procedure as in the synthesis of compound 8 except that polyethylene glycol monomethyl ether (number-average molecular weight: 400) was changed to polyethylene glycol monomethyl ether (number-average molecular weight: 600). The obtained compound 9 was an HDI with an allophanate structure, and its isocyanate content was 20.0%.

### Synthesis of Urethane Resins

### Urethane Resins 1 to 25

To a four-necked flask equipped with a stirrer, a thermometer, a nitrogen gas introducing tube, and a reflux tube, a polyisocyanate and either a polyol or a polyamine were added in the amounts indicated in Table 1 with 300.0 parts of methyl ethyl ketone. The reaction was allowed to proceed in a nitrogen atmosphere at a temperature of 80° C. for 7 hours. The amounts of the polyisocyanate and the polyol or polyamine were determined in such a manner that “the number of moles of isocyanate groups”>“the number of moles of hydroxy groups or amino groups.”

Then DMPA, a cross-linking agent, and a chain extender were added in the amounts indicated in Table 1. While the proportion of unreacted isocyanate groups was monitored by FT-IR, the reaction was allowed to proceed at a temperature of 80° C. until a desired proportion was reached, yielding a reaction solution. The purpose of this adjustment of the proportion of unreacted isocyanate groups was to obtain a desired molar ratio of urethane bonds/urea bonds. After the obtained reaction liquid was cooled to a temperature of 40° C., ion-exchanged water was added. An aqueous potassium hydroxide solution was added while the mixture was quickly stirred with a homogenizing mixer, yielding a resin-containing liquid. The obtained liquid was heated under reduced pressure until methyl ethyl ketone was distilled away. In this way, liquids that contained urethane resins 1 to 25 were obtained with a urethane resin content (solid content) of 42.9%. Table 1 also presents some characteristics of the urethane resins.

TABLE 1
Urethane resins 1 to 25: conditions of synthesis and characteristics

| | | Components used to synthesize the urethane resin (parts) | | | | | | | |
|---|---|---|---|---|---|---|---|---|---|
| | | | Polyol or polyamine | | | | Characteristics of the urethane resin | | |
| | | | (for polyols, the value | | Cross- | | | Gel | Molar ratio of |
| | | | represents the number- | | linking | Chain | Acid value | fraction | urethane bonds/ |
| | | Polyisocyanate | average molecular weight) | DMPA | agent | extender | (mg KOH/g) | (%) | urea bonds |
| Urethane | 1 | Compound 1: 57.1 | PPG2,000: 136.3 | 2.4 | TMP: 3.8 | EDA: 0.4 | 5 | 94 | 95.0/5.0 |
| resin | 2 | Compound 1: 61.7 | PPG2,000: 129.8 | 4.3 | TMP: 3.8 | EDA: 0.4 | 9 | 94 | 95.0/5.0 |
| number | 3 | Compound 1: 51.3 | PPG2,000: 144.4 | — | TMP: 3.8 | EDA: 0.4 | 0 | 94 | 95.0/5.0 |
| | 4 | Compound 2: 57.1 | PPG2,000: 136.3 | 2.4 | TMP: 3.8 | EDA: 0.4 | 5 | 94 | 95.0/5.0 |
| | 5 | Compound 3: 57.1 | PPG2,000: 136.3 | 2.4 | TMP: 3.8 | EDA: 0.4 | 5 | 94 | 95.0/5.0 |
| | 6 | Compound 4: 57.1 | PPG2,000: 136.3 | 2.4 | TMP: 3.8 | EDA: 0.4 | 5 | 94 | 95.0/5.0 |
| | 7 | Compound 1: 57.0 | PPG2,000: 137.6 | 2.4 | GLY: 2.6 | EDA: 0.4 | 5 | 94 | 95.0/5.0 |
| | 8 | Compound 1: 51.3 | PPG2,000: 143.4 | 2.4 | TMP: 2.5 | DETA: 0.4 | 5 | 94 | 95.0/5.0 |
| | 9 | Compound 1: 50.9 | PPG2,000: 143.8 | 2.4 | TMP: 2.5 | TETA: 0.5 | 5 | 94 | 95.0/5.0 |
| | 10 | Compound 1: 160.3 | HMDA: 1.9 | 2.4 | TMP: 3.8 | NPG: 31.6 | 5 | 94 | 95.0/5.0 |
| | 11 | Compound 1: 57.1 | PE2,000: 136.3 | 2.4 | TMP: 3.8 | EDA: 0.4 | 5 | 94 | 95.0/5.0 |
| | 12 | Compound 1: 57.1 | PC2,000: 136.3 | 2.4 | TMP: 3.8 | EDA: 0.4 | 5 | 94 | 95.0/5.0 |
| | 13 | Compound 1: 57.1 | PTMG2,000: 136.3 | 2.4 | TMP: 3.8 | EDA: 0.4 | 5 | 94 | 95.0/5.0 |
| | 14 | Compound 1: 57.1 | PEG2,000: 136.3 | 2.4 | TMP: 3.8 | EDA: 0.4 | 5 | 94 | 95.0/5.0 |
| | 15 | Compound 5: 57.1 | PPG2,000: 136.3 | 2.4 | TMP: 3.8 | EDA: 0.4 | 5 | 94 | 95.0/5.0 |
| | 16 | Compound 6: 52.0 | PPG2,000: 142.8 | 2.4 | TMP: 2.5 | EDA: 0.4 | 5 | 94 | 95.0/5.0 |
| | 17 | Compound 7: 52.0 | PPG2,000: 142.8 | 2.4 | TMP: 2.5 | EDA: 0.4 | 5 | 94 | 95.0/5.0 |
| | 18 | Compound 1: 53.9 | PPG2,000: 140.3 | 2.4 | TMP: 3.0 | EDA: 0.4 | 5 | 88 | 95.0/5.0 |
| | 19 | Compound 1: 42.2 | PPG2,000: 155.1 | 2.4 | — | EDA: 0.3 | 5 | 81 | 95.0/5.0 |
| | 20 | Compound 1: 59.6 | PPG2,000: 133.4 | 2.4 | TMP: 3.8 | EDA: 0.9 | 5 | 94 | 90.0/10.0 |
| | 21 | Compound 1: 60.1 | PPG2,000: 132.8 | 2.4 | TMP: 3.8 | EDA: 0.9 | 5 | 94 | 89.0/11.0 |
| | 22 | Compound 1: 62.3 | PPG2,000: 130.1 | 2.4 | TMP: 3.8 | EDA: 1.3 | 5 | 94 | 85.0/15.0 |
| | 23 | Compound 1: 62.9 | PPG2,000: 129.5 | 2.4 | TMP: 3.8 | EDA: 1.4 | 5 | 94 | 84.0/16.0 |
| | 24 | HDI: 13.9 | PPG2,000: 179.4 | 2.4 | TMP: 3.8 | EDA: 0.5 | 5 | 94 | 95.0/5.0 |
| | 25 | Compound 1: 63.1 | PPG2,000: 127.9 | 4.8 | TMP: 3.8 | EDA: 0.5 | 10 | 94 | 95.0/5.0 |

### Liquid Containing Urethane Resin 26

To a reaction vessel equipped with a stirrer, a thermometer, a nitrogen sealing tube, and a condenser, 128.6 g of PTMG (number-average molecular weight: 2,000) and 8.0 g of NPG were added. The materials were mixed at a temperature of 100° C. until the mixture was uniform. Then 165.6 g of compound 8 and 0.05 g of dibutyltin dilaurate were added. The reaction was allowed to proceed at a temperature of 80° C. for 3 hours, yielding a prepolymer-containing solution. The isocyanate content of the prepolymer (solid) was 2.32%, and the viscosity at a temperature of 75° C. was 1,150 mPa·s.

After emulsification through the addition of 702.0 g of water to the obtained prepolymer-containing solution, terminal isocyanate groups of the prepolymer were extended through a reaction with water at a temperature of 40° C. The reaction was terminated when it was confirmed by FT-IR that no isocyanate groups were present, yielding a liquid that contained urethane resin 26. The urethane resin (solid) content, the viscosity, and the pH of this liquid was 30.1%, 40 mPa·s, and 7.0, respectively. The average particle diameter of the urethane resin was 130 nm.

### Liquid Containing Urethane Resin 27

To a four-necked flask equipped with a stirrer, a thermometer, a nitrogen introduction tube, and a reflux tube, 135.8 parts of PPG (number-average molecular weight: 2,000) and methyl ethyl ketone were added. After complete dissolution, 31.7 parts of compound 9 and 31.7 parts of IPDI were added. The reaction was allowed to proceed in a nitrogen atmosphere at a temperature of 75° C. for 1 hour, yielding a prepolymer-containing solution. After the obtained solution was cooled to a temperature of 40° C., ion-exchanged water was added. The mixture was quickly stirred with a homogenizing mixer until emulsification. Then 0.9 parts of EDA was added, and the chain extension reaction was allowed to proceed at a temperature of 30° C. for 12 hours while the proportion of unreacted isocyanate groups was monitored by FT-IR. After the proportion of unreacted isocyanate groups was zero, the resin-containing liquid was heated under reduced pressure until methyl ethyl ketone was distilled away. In this way, a liquid that contained urethane resin 27 was obtained with a urethane resin content (solid content) of 42.9%.

### Preparation of Pigment Dispersion Liquids

### Pigment Dispersion Liquid 1

The following materials were mixed: 20.0 g of carbon black, 7.0 mmol of the monosodium salt of ((4-aminobenzoylamino)-methan-1,1-diyl)bisphosphonic acid, 20.0 mmol of nitric acid, and 200.0 mL of purified water. The mixture was homogenized at room temperature at 6,000 rpm with a Silverson mixer. Thirty minutes later, a solution of 20.0 mmol of sodium nitrite in a small amount of water was slowly added to the mixture. This mixing operation increased the temperature of the mixture to 60° C., at which the reaction was allowed to proceed for 1 hour. Then the pH of the mixture was adjusted to 10 with an aqueous sodium hydroxide solution. Thirty minutes later, 20.0 mL of purified water was added, and diafiltration was performed with the use of SPECTRUM membranes. Ion exchange was performed to change the counter ion of the anionic group of the self-dispersible pigment from sodium ions to potassium ions, and then the concentration of solid pigment was adjusted. In this way, pigment dispersion liquid 1 was obtained. Pigment dispersion liquid 1 contained a self-dispersible pigment in which ((4-aminobenzoylamino)-methan-1,1-diyl)bisphosphonic acid groups whose counter ion was potassium were bonded to surfaces of particles, and its pigment content was 30.0%.

### Pigment Dispersion Liquid 2

To a solution of 5.0 g of concentrated hydrochloric acid in 5.5 g of water, 1.5 g of 4-amino-1,2-benzenedicarboxylic acid cooled to a temperature of 5° C. was added. A solution of 1.8 g of sodium nitrite in 9.0 g of water at 5° C. was added to the first solution with the temperature maintained at 10° C. or lower by stirring the solution with the vessel in an ice bath. After an additional 15-minute stirring of the mixed solution, 6.0 g of carbon black was added while the solution was stirred. Additional 15 minutes of stirring yielded slurry. The obtained slurry was filtered through a filter paper (trade name “Standard Filter Papers No. 2,” ADVANTEC), and the collected pigment particles were thoroughly washed with water and dried in an oven at a temperature of 110° C. The prepared self-dispersible pigment was subjected to ion exchange, which changed the counter ion of the anionic group of the self-dispersible pigment from sodium ions to potassium ions, and then the concentration of solid pigment was adjusted. In this way, pigment dispersion liquid 2 was obtained. Pigment dispersion liquid 2 contained a self-dispersible pigment in which —C₆H₃—(COOK)₂ groups were bonded to surfaces of particles, and its pigment content was 30.0%.

### Pigment Dispersion Liquid 3

To a reaction vessel 500.0 g of carbon black, 45.0 g of aminophenyl(2-sulfoethyl)sulfone (APSES), and 900.0 g of distilled water were added. The mixture was stirred at a temperature of 55° C. and a revolution speed of 300 rpm for 20 minutes. To the stirred mixture 40.0 g of a 25.0% aqueous sodium nitrite solution was added dropwise over 15 minutes, and then 50.0 g of distilled water was added. The reaction was allowed to proceed at a temperature of 60° C. for 2 hours, yielding a reaction product. The obtained reaction product was collected through dilution with distilled water, and the concentration of solid pigment was adjusted. In this way, a dispersion liquid was obtained with a pigment content of 15.0%. Impurities were removed by centrifugation, yielding dispersion liquid A. Dispersion liquid A contained a pigment in which APSES was bonded to surfaces of particles.

The number of moles of functional groups bonded to the pigment in dispersion liquid A was determined by the following operations. The sodium ion concentration in dispersion liquid A was measured with a sodium ion electrode (1512A-10C, HORIBA), and the measurement was converted to the number of moles per gram of solid pigment (mol/g). Then dispersion liquid A, the pigment content of which was 15.0%, was added dropwise to a pentaethylenehexamine (PEHA) solution over 1 hour while being vigorously agitated, yielding a mixture. The concentration of PEHA in the PEHA solution was 1 to 10 times greater than the determined number of moles of sodium ions, and the volume of the solution was equal to that of dispersion liquid A. After 18 to 48 hours of stirring of the mixture, impurities were removed, yielding dispersion liquid B. Dispersion liquid B contained a pigment in which PEHA were bonded to surfaces of particles via APSES, and its pigment content was 10.0%.

A water-soluble styrene-acrylic acid copolymer was prepared (weight-average molecular weight, 8,000; acid value, 140 mg KOH/g; dispersity Mw/Mn, 1.5 [Mw, weight-average molecular weight; Mn, number-average molecular weight]). To 1,800 g of distilled water, 190.0 g of this water-soluble resin was added. Potassium hydroxide was added in an amount required to neutralize the resin. The mixture was stirred until dissolution, yielding an aqueous resin solution. To the obtained aqueous resin solution, 500.0 g of dispersion liquid B, the pigment content of which was 10.0%, was added dropwise, yielding a mixture. The mixture was heated on an evaporating dish at a temperature of 150° C. for 15 hours until liquid components evaporated, and then the dry residue was cooled to room temperature. The dry residue was added to distilled water with a pH of 9.0 adjusted with potassium hydroxide and dispersed with a dispersing machine. A 1.0 mol/L aqueous potassium hydroxide solution was added until the pH of the solution was 10 to 11 while the solution was stirred. Then impurities and coarse particles were removed by demineralization and purification. In this way, pigment dispersion liquid 3 was obtained. Pigment dispersion liquid 3 contained a resin-bonded self-dispersible pigment in which organic groups containing a polymer (the water-soluble styrene-acrylic acid copolymer) were bonded to surfaces of particles. Its pigment content was 30.0%, and its resin content was 15.0%.

### Pigment Dispersion Liquid 4

A mixture of 500.0 g of ion-exchanged water and 15.0 g of carbon black was stirred at 15,000 rpm for 30 minutes for preliminary moistening of the pigment. After the addition of 4,485 g of ion-exchanged water, the pigment was dispersed with a high-pressure homogenizer, yielding dispersion liquid C. The average particle diameter of the pigment in dispersion liquid C was 110 nm. The obtained dispersion liquid C was transferred to a pressure vessel and compressed with a pressure of 3.0 MPa. The pigment was ozonated through the introduction of ozone water with an ozone concentration of 100 ppm, yielding dispersion liquid D. The pH of dispersion liquid D was adjusted to 10.0 with potassium hydroxide, and the concentration of solid pigment was adjusted. In this way, pigment dispersion liquid 4 was obtained. Pigment dispersion liquid 4 contained a self-dispersible pigment in which —COOK groups were bonded to surfaces of particles, and its pigment content was 30.0%.

### Pigment Dispersion Liquid 5

The following materials were mixed, yielding a mixture: 10.0 g of carbon black, 20.0 g of a water-soluble resin, and 70.0 g of water. The water-soluble resin was a styrene-acrylic acid copolymer with an acid value of 200 mg KOH/g and a weight-average molecular weight of 10,000 neutralized with a 10.0% aqueous sodium hydroxide solution. After a 1-hour dispersion in the mixture with a sand grinder, impurities were removed by centrifugation, and pressure filtration was performed with the use of a microfilter with a pore size of 3.0 μm (Fujifilm). Then the concentration of solid pigment was adjusted. In this way, pigment dispersion liquid 5 was obtained with a pH of 10.0. Pigment dispersion liquid 5 contained pigment dispersed by the water-soluble resin (a resin dispersant). Its pigment content was 30.0%, and its resin content was 15.0%.

### Preparation of Inks

### Examples 1 to 31 and Comparative Examples 2 to 4 and 6

The inks of Examples 1 to 31 and Comparative Examples 2 to 4 and 6 were prepared by the following method. The components listed below were mixed, and the mixture was thoroughly stirred. Then pressure filtration was performed with the use of a microfilter with a pore size of 3.0 μm (Fujifilm). Acetylenol E100 is a nonionic surfactant (an acetylene glycol ethylene oxide adduct) available from Kawaken Fine Chemicals, and the “balance” for ion-exchanged water refers to the amount that makes the total amount of all components of the ink 100.0%. The ink of Comparative Example 2 was prepared without the use of any liquid containing urethane resin.
Pigment dispersion liquid (specified in Table 2): 10.0%
Liquid containing urethane resin (specified in Table 2): Amount (%) specified in Table 2
Glycerin: 9.0%
Triethylene glycol: 5.0%
Acetylenol E100:0.1%
Ion-exchanged water: Balance

### Comparative Example 1

The following materials were mixed, yielding a mixture: 35.0 parts of a liquid containing urethane resin 1 and 3.0 parts of carbon black. To the obtained mixture 45.0 parts of glass beads (a dispersion medium) was added. After a 2-hour dispersion with a paint shaker, the glass beads were removed, yielding a dispersion liquid. The obtained dispersion liquid was mixed with 9.0 parts of glycerin, 5.0 parts of triethylene glycol, 0.1 parts of Acetylenol E100 (Kawaken Fine Chemicals), and 40.9 parts of ion-exchanged water, and the mixture was thoroughly stirred. Then pressure filtration was performed with the use of a microfilter with a pore size of 3.0 μm (Fujifilm). In this way, the ink of Comparative Example 1 was prepared.

### Comparative Example 5

The following materials were mixed, yielding a mixture: 33.4 parts of a liquid containing urethane resin 26, 40.0 parts of titanium white, 21.6 parts of water, and 5.0 parts of isopropanol. To the obtained mixture 100.0 parts of glass beads (a dispersion medium) was added. After a 2-hour dispersion with a paint shaker, the glass beads were removed, yielding a dispersion liquid. To the obtained dispersion liquid 8.0 parts of a self-emulsifiable polyisocyanate (trade name “AQUANATE 200,” Nippon Polyurethane Industry) was added in the form of water emulsion (the mass ratio of AQUANATE 200 to water is 100:100), and the mixture was thoroughly stirred. In this way, the ink of Comparative Example 5 was prepared.

### Evaluation

The obtained inks were individually put into ink cartridges and loaded into an ink jet recording apparatus configured to eject ink from a recording head using thermal energy (trade name “PIXUS iP3100,” CANON KABUSHIKI KAISHA). In the Examples, the recording duty of a solid image recorded under conditions that ensure one drop of the ink is applied to a unit area of 1/600 inches× 1/600 inches having a mass per droplet of 28 ng±10% is defined as 100%. The recording conditions were as follows: temperature, 23° C.; relative humidity, 55%. In certain aspects of the invention, grades (AA,) A and B in the evaluation criteria below mean that the ink was acceptable in terms of the specific assessment, and C means that the ink was unacceptable. The results of the evaluation are summarized in Table 2. Table 2 also presents some characteristics of the individual inks.

### Scratch Resistance

A recorded article was obtained through the recording of a 1.0-inch×0.5-inch solid image with the aforementioned ink jet recording apparatus at a recording duty of 100% on a sheet of plain paper (trade name “PPC Printing Paper GF-500,” CANON KABUSHIKI KAISHA). Ten minutes and one day after the recording, a piece of silbon paper and a weight with a contact pressure of 40 g/cm² were placed on the solid image on the recorded article, and the solid image and the silbon paper were rubbed with each other. After the silbon paper and the weight were removed, the margin was visually inspected for smearing, and the scratch resistance was evaluated as per the following criteria.

A: Little smearing was found in the white background area at 10 minutes, and no smearing was found in the white background area at 1 day.

B: Little smearing was found in the white background area both at 10 minutes and at 1 day.

C: Although smearing was found in the white background area at 10 minutes, the smears were not very noticeable. Little smearing was found in the white background area at 1 day.

### Intermitted Ejection Stability

For each ink, 10,000 ink droplets were ejected with the aforementioned ink jet recording apparatus through all nozzles of the recording head at a temperature of 15° C.±2° C. and a relative humidity of 10% with the drive frequency set at 5 kHz. After a 0.5-inch space, the ink was ejected through one of the nozzles to record a horizontal line of four dots in width (four droplets of the ink). Then after a 1.5-second pause in ejection, the ink was ejected through the same nozzle to record another horizontal line of four dots in width. The two horizontal lines recorded before and after a 1.5-second pause in this way were visually inspected, and the intermittent ejection stability was evaluated as per the following criteria.

AA: No deflections were found in the horizontal line recorded after the pause in ejection, and the widths of the two horizontal lines recorded before and after the pause in ejection were equivalent.

A: Although some deflections were found in the horizontal line recorded after the pause in ejection, the widths of the two horizontal lines recorded before and after the pause in ejection were equivalent.

B: Some deflections were found in the horizontal line recorded after the pause in ejection, and the width of the horizontal line recorded after the pause in ejection was smaller than that of the line recorded before the pause.

C: Some deflections were found in the horizontal line recorded after the pause in ejection, and the width of the horizontal line recorded after the pause in ejection was considerably smaller than that of the line recorded before the pause.

TABLE 2
Composition, characteristics, and evaluations of the inks

| | | Composition and characteristics of the ink | | | | | | | |
|---|---|---|---|---|---|---|---|---|---|
| | | | Urethane-resin- | | | | | Evaluations | |
| | | Pigment | containing liquid | | Content in the ink | | A/B mass | | Intermittent |
| | | dispersion | Urethane | Amount | Pigment | Urethane | ratio | Scratch | ejection |
| | | liquid No. | resin No. | (%) | A (%) | resin B (%) | (times) | resistance | stability |
| Examples | 1 | 1 | 1 | 35.0 | 3.0 | 15.0 | 5.0 | A | AA |
| | 2 | 2 | 1 | 35.0 | 3.0 | 15.0 | 5.0 | A | AA |
| | 3 | 3 | 1 | 35.0 | 3.0 | 15.0 | 5.0 | A | AA |
| | 4 | 4 | 1 | 35.0 | 3.0 | 15.0 | 5.0 | A | AA |
| | 5 | 5 | 1 | 35.0 | 3.0 | 15.0 | 5.0 | A | AA |
| | 6 | 1 | 2 | 35.0 | 3.0 | 15.0 | 5.0 | A | AA |
| | 7 | 1 | 3 | 35.0 | 3.0 | 15.0 | 5.0 | A | AA |
| | 8 | 1 | 4 | 35.0 | 3.0 | 15.0 | 5.0 | A | AA |
| | 9 | 1 | 5 | 35.0 | 3.0 | 15.0 | 5.0 | A | AA |
| | 10 | 1 | 6 | 35.0 | 3.0 | 15.0 | 5.0 | A | AA |
| | 11 | 1 | 7 | 35.0 | 3.0 | 15.0 | 5.0 | A | AA |
| | 12 | 1 | 8 | 35.0 | 3.0 | 15.0 | 5.0 | A | AA |
| | 13 | 1 | 9 | 35.0 | 3.0 | 15.0 | 5.0 | A | AA |
| | 14 | 1 | 10 | 35.0 | 3.0 | 15.0 | 5.0 | B | AA |
| | 15 | 1 | 11 | 35.0 | 3.0 | 15.0 | 5.0 | B | AA |
| | 16 | 1 | 12 | 35.0 | 3.0 | 15.0 | 5.0 | B | AA |
| | 17 | 1 | 13 | 35.0 | 3.0 | 15.0 | 5.0 | B | AA |
| | 18 | 1 | 14 | 35.0 | 3.0 | 15.0 | 5.0 | B | AA |
| | 19 | 1 | 15 | 35.0 | 3.0 | 15.0 | 5.0 | B | AA |
| | 20 | 1 | 16 | 35.0 | 3.0 | 15.0 | 5.0 | B | AA |
| | 21 | 1 | 17 | 35.0 | 3.0 | 15.0 | 5.0 | B | AA |
| | 22 | 1 | 18 | 35.0 | 3.0 | 15.0 | 5.0 | A | AA |
| | 23 | 1 | 19 | 35.0 | 3.0 | 15.0 | 5.0 | B | AA |
| | 24 | 1 | 20 | 35.0 | 3.0 | 15.0 | 5.0 | A | AA |
| | 25 | 1 | 21 | 35.0 | 3.0 | 15.0 | 5.0 | A | A |
| | 26 | 1 | 22 | 35.0 | 3.0 | 15.0 | 5.0 | A | A |
| | 27 | 1 | 23 | 35.0 | 3.0 | 15.0 | 5.0 | A | B |
| | 28 | 1 | 1 | 0.28 | 3.0 | 0.12 | 0.04 | B | AA |
| | 29 | 1 | 1 | 0.35 | 3.0 | 0.15 | 0.05 | A | AA |
| | 30 | 1 | 1 | 69.9 | 3.0 | 30.0 | 10.0 | A | AA |
| | 31 | 1 | 1 | 76.9 | 3.0 | 33.0 | 11.0 | A | A |
| Comparative | 1 | * | * | * | 3.0 | 15.0 | 5.0 | C | C |
| Examples | 2 | 1 | — | — | 3.0 | — | — | C | AA |
| | 3 | 1 | 24 | 35.0 | 3.0 | 15.0 | 5.0 | B | C |
| | 4 | 1 | 25 | 35.0 | 3.0 | 15.0 | 5.0 | C | AA |
| | 5 | * | * | * | 40.0 | 10.1 | 0.25 | C | C |
| | 6 | 1 | 27 | 35.0 | 3.0 | 15.0 | 5.0 | C | C |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-130038 filed Jun. 20, 2013, which is hereby incorporated by reference herein in its entirety.

What is claimed is:

1. An ink for ink jet, comprising a pigment and a urethane resin;
wherein the pigment contains at least one of a pigment having an anionic group bonded to a surface of a particle thereof directly or via another atomic group and a pigment dispersed by a resin having an anionic unit and different from the urethane resin,
wherein the urethane resin contains a unit derived from a polyfunctional polyisocyanate, the unit derived from the polyfunctional polyisocyanate having at least one structure selected from the group consisting of an allophanate structure having added a monohydric alcohol containing 1 to 5 carbon atoms, a uretdione structure, an isocyanurate structure, and a biuret structure, and
wherein an acid value of the urethane resin is less than 10 mg KOH/g.

2. The ink according to claim 1, wherein the urethane resin contains a unit derived from a polyol.

3. The ink according to claim 2, wherein the polyol includes a polyether polyol.

4. The ink according to claim 3, wherein the polyether polyol includes a polypropylene glycol.

5. The ink according to claim 1, wherein the unit derived from the polyfunctional polyisocyanate has an allophanate structure that has added a monohydric alcohol containing 1 to 5 carbon atoms.

6. The ink according to claim 1, wherein a gel fraction of the urethane resin is 88% by mass or more.

7. The ink according to claim 1, wherein a molar ratio of a proportion in % by mole of a urethane bond in the urethane resin to a proportion in % by mole of a urea bond is 85.0/15.0 or more.

8. The ink according to claim 1, wherein a molar ratio of a proportion in % by mole of a urethane bond in the urethane resin to a proportion in % by mole of a urea bond is 90.0/10.0 or more.

9. The ink according to claim 1, wherein a mass ratio of a content in % by mass of the urethane resin to a content in % by mass of the pigment based on a total mass of the ink is 0.05 times or more and 10.0 times or less.

10. An ink cartridge, comprising an ink and an ink storage portion storing the ink;
wherein the ink contains the ink according to claim 1.

11. An ink jet recording method, comprising ejecting ink from an ink jet recording head to record an image on a record medium;
wherein the ink contains the ink according to claim 1.
